(19) United States
(12) Patent Application Publication
(10) Pub. No.: US 2004/0202795 A1
(43) Pub. Date: Oct. 14, 2004

(54) Screen printing process

(75) Inventor: George E. Sakoske, Washington, PA (US)

Correspondence Address: RANKIN, HILL, PORTER & CLARK, LLP, 925 EUCLID AVENUE, SUITE 700, CLEVELAND, OH, 44115-1405, US

(73) Assignee: Ferro Glass & Color Corporation, Washington, PA

(21) Appl. No.: 10/791,215

(22) Filed: Mar. 2, 2004

Related U.S. Application Data
(63) Continuation of application No. 09/941,363, filed on Aug. 28, 2001, now abandoned.

(51) Int. Cl. B05D 3/00

(52) U.S. Cl. 427/554

(57) ABSTRACT

A method of screen printing and laser ablating various types of substrates is disclosed. The process may be used to make decorated auto glass with additional indicia such as serial numbers, bar codes, and the like. The substrate with the applied coating may subsequently be shape formed and/or heat strengthened to produce a final product. The invention also provides a screen and a screen printed pattern which include a portion that is subsequently laser ablated to provide specific information such as serialization. In one embodiment, the screen printed and laser ablated glass substrate is fired. In another embodiment, screen printed patterns may be laser ablated with no subsequent heat treatment required.

### RELATED APPLICATION

This application is a continuation of application Ser. No. 09/941,363 filed Aug. 28, 2001 which is incorporated herein by reference.

### FIELD OF THE INVENTION

The present invention relates to a screen printing process, and more particularly relates to a process in which a substrate such as glass is screen printed, a portion of the printed area is laser ablated, and the printed substrate is fired. The glass substrate may comprise automotive glass, television glass, appliance glass, lighting glass, architectural glass, container glass or the like.

### BACKGROUND INFORMATION

Automotive glass manufacturers have recently been interested in tracing parts and quality of automotive glass products. One proposed approach is to set up a line after the decorated automotive glass has been fired in order to apply indicia such as quality information, serial numbers, bar codes, two-dimensional patch codes, logos and other types of serialization. However, several drawbacks are associated with this approach. A separate production line is needed to handle the parts, for example, to reapply paint, laser mark, remove excess paint, clean and then re-inspect the part. Also, when laser marking, localized heating of a cold glass substrate to temperatures required to fuse the laser mark with the glass substrate may result in significant strength degradation of the glass substrate. Similar difficulties may be experienced for glass substrates in the architectural, container, lighting and other industries.

A need exists for a process that can economically serialize glass parts using existing screen printing lines which may also include, for example, forming, annealing and/or tempering lines. Conventional techniques use individual screens, for example, with an individual serial number, which is not economically feasible for mass production. Currently, manufacturers can include a single part number on a screen. However, individualized information such as date, time, line, shift, quality, etc. is not possible.

The present invention has been developed in view of the foregoing, and to address other deficiencies of the prior art.

### SUMMARY OF THE INVENTION

The invention provides a method of screen printing, laser ablation serializing, and then firing a glass substrate. The substrate with the applied coating may subsequently be shape formed and/or strengthened to produce a final product. The invention also provides a screen printed pattern which includes a portion that is subsequently laser ablated to provide specific information such as serialization. In one embodiment, the screen printed and laser ablated glass substrate is fired. In another embodiment, screen printed patterns made from, e.g., organic coatings, may be laser ablated with no subsequent heat treatment required.

Uses of the present process include many applications such as automotive, architectural, electronics, military and other industrial applications. An advantage of the present invention is the ability to serialize screen printed materials in order to track identification, dates, shifts, lines, production lots, etc. using a single screen for the screen printing process and a laser ablation technique, instead of individual screens for each serialization requirement. Manufacturers are therefore able to use an in-line process with very little modification. Also, by avoiding localized heating, e.g., during fusing of a laser mark, the glass substrate will not experience strength degradation.

An aspect of the present invention is to provide a method of providing indicia on a substrate. The method includes the steps of screen printing a substrate to make a decorated portion and a laser ablation portion on the substrate, and laser ablating the laser ablation portion to provide indicia on the substrate.

Another aspect of the present invention is to provide a method of providing indicia on automotive glass. The method comprises screen printing the automotive glass to make a decorated portion and a laser ablation portion on the automotive glass, and laser ablating the laser ablation portion to provide indicia on the automotive glass.

A further aspect of the present invention is to provide a screen printed substrate including a screen printed decorated portion and a screen printed laser ablation portion configured for subsequent laser ablation.

Another aspect of the present invention is to provide a screen printed and laser ablated substrate comprising a screen printed decorated portion of the substrate and a screen printed laser ablated portion of the substrate.

A further aspect of the present invention is to provide a screen printing screen comprising a decoration portion and a separate laser ablation portion.

These and other aspects of the present invention will be more apparent from the following description.

### BRIEF DESCRIPTION OF THE DRAWINGS

FIG. 1 is a schematic diagram of a conventional process of forming and decorating an automotive glass substrate.

FIG. 2 is a schematic diagram of a process of forming and decorating an automotive glass substrate in accordance with an embodiment of the present invention. The decorating process includes the steps of screen printing, laser ablating a portion of the printed area, and firing the glass substrate.

FIG. 3a is a partially schematic front view of an automotive glass substrate after it has been screen printed, but before a portion of the screen printed area has been laser ablated, in accordance with an embodiment of the present invention.

FIG. 3b is a partially schematic front view of an automotive glass substrate after it has been screen printed and after a portion of the screen printed area has been laser ablated in accordance with an embodiment of the present invention.

FIGS. 4a-4c are partially schematic cross-sectional views of a glass substrate illustrating a laser ablation process in accordance with an embodiment of the present invention.

### DETAILED DESCRIPTION

In accordance with the present invention, many substrates may be coated for functional or decorative reasons with various coatings. By screen printing a coating on the substrate and then selectively removing portions of the screen printed coating with a laser beam, the substrate can be marked, decorated, serialized or patterned with a simple operation. For example, automotive glass windshields, backlights and side windshields are routinely decorated around their perimeter for functional and decorative reasons with a band of black enamel. A portion of the black enamel may be selectively removed with a laser beam, allowing serialization of each piece of glass prior to firing. Similarly, glass containers are commonly decorated with glass enamels. Marking by selective removal of a portion of the enamel with a laser prior to firing may be used to enhance the decoration as well as to include bar coding or serialization on the container. The same process can be used to mark metals, ceramics, plastics, papers, transfer decals and other components.

Conventional screen printing techniques use a screen supported stencil to form a layer of ink on a substrate in a desired pattern. The stencil is made by stretching a screen fabric, typically polyester, across a frame, and then coating the screen with a photosensitive emulsion. The emulsion-coated screen is photoexposed to harden the emulsion in areas not masked from the light. The unhardened areas of the emulsion are removed in order to complete the stencil. During the screen printing process, ink is forced through the patterned stencil onto the substrate.

In accordance with an embodiment of the present invention, by redesigning the printing screens and including a laser ablation process in existing lines, glass parts can be serialized and tracked for date, time, line, type of glass, type of paint, etc. for traceability as required by new QS9000 quality standards. Furthermore, after inspection, a computer may be used to separate the parts into grades of quality for different standards such as OEM or aftermarket. Furthermore, a part in the field may be traced back to the exact manufacturing place and conditions by the serial number or other similar indicia.

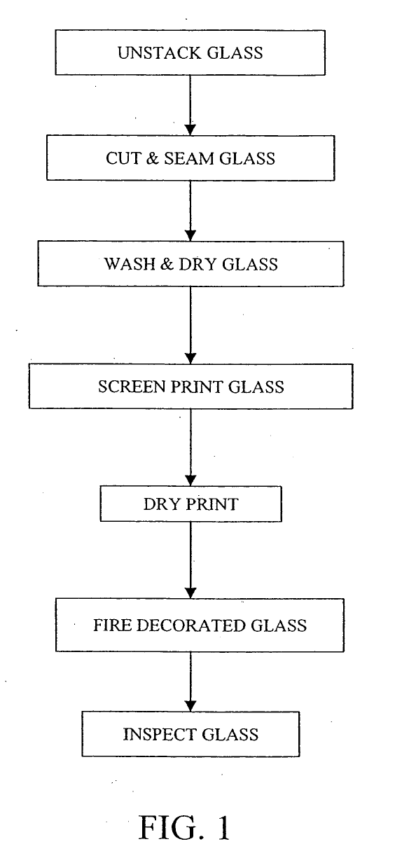

FIG. 1 schematically illustrates a conventional process of forming and decorating an automotive glass part. In the first step, the glass is unstacked. The individual glass sheet is then cut and seamed using conventional equipment. The cut and seamed glass sheet is then washed and dried using standard techniques. Next, the glass sheet is screen printed by conventional techniques. The decorated glass is then fired, typically at a temperature of from about 580 to about 660° C. After firing, the glass part is inspected in accordance with applicable quality control standards.

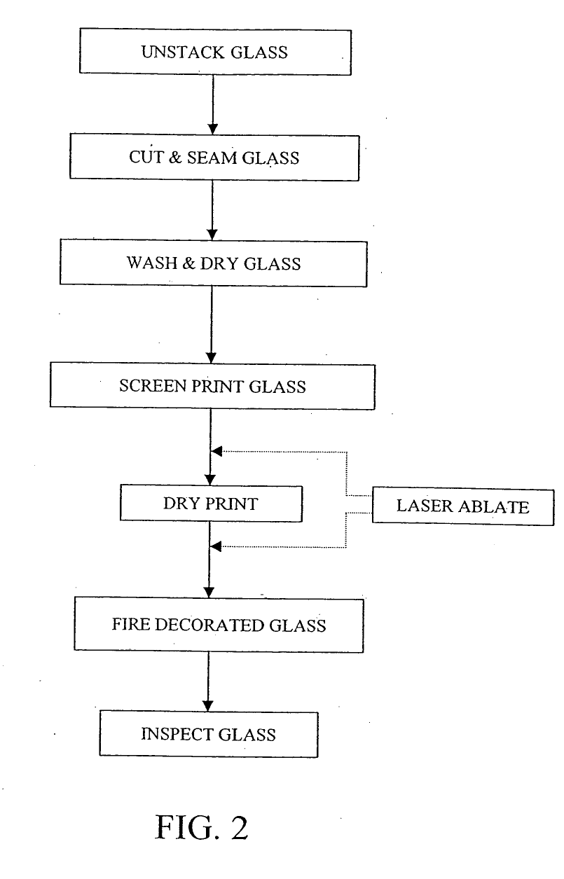

FIG. 2 is a schematic diagram of a process of forming and decorating an automotive glass part in accordance with an embodiment of the present invention. The process illustrated in FIG. 2 is similar to the process shown in FIG. 1, but with a different screen printed pattern and with the addition of a laser ablation step after the screen printing step. As shown in FIG. 2, laser ablation may occur directly after screen printing, or may occur after the drying step. The print may be ablated while it is either wet immediately after screen printing, or after it has been dried to remove the solvents and harden the print to a green state. The material that is coated on the automotive glass during the screen printing process may comprise, for example, black glass enamel having a composition of 49 weight percent glass frit, 25 weight percent pigment, 6 weight percent crystal seed powder, and 20 weight percent printing medium.

In accordance with the present invention as illustrated in FIG. 2, in addition to screen printing a standard decoration on the automotive glass part, during the screen printing step, an extra area of the glass substrate is coated for subsequent laser ablation. This extra screen printing area of the glass substrate is the “screen printed laser ablation portion”. This portion is laser ablated, and the substrate may subsequently be fired. In accordance with an embodiment of the present invention, during the firing step the glass is heated to fuse the ceramic enamel decoration, heat strengthen the glass, and shape or form the glass sheet all in one operation. Thus, the substrate may be bent during the firing step, for example, by shaping or forming operations conventionally used in the manufacture of automotive glass.

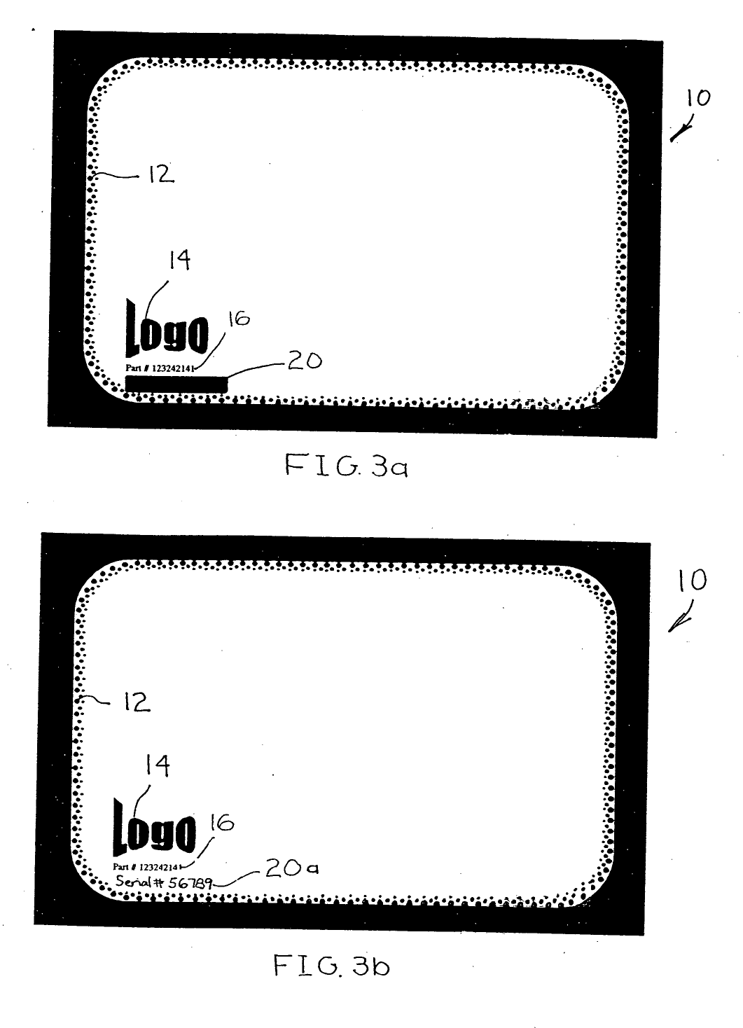

FIG. 3a is a partially schematic front view of an automotive glass substrate 10 after it has been screen printed in accordance with an embodiment of the present invention, but before a portion of the screen printed area has been laser ablated. In addition to a standard decorated border 12, logo 14 and part number 16, the screen printed automotive glass substrate 10 shown in FIG. 3a includes a blank band of the screen printed material which provides a screen printed laser ablation portion 20 that will be laser ablated in a subsequent operation. The screen assembly used to print the pattern shown in FIG. 3a may be a conventional screen assembly, with an additional opening provided through the screen assembly in order to produce the laser ablation portion 20.

FIG. 3b is a partially schematic front view of the automotive glass substrate 10 of FIG. 3a, after the laser ablation portion 20a of screen printed material has been laser ablated in accordance with an embodiment of the present invention. In the embodiment shown in FIG. 3b, the laser ablated portion 20a comprises a serial number comprising alphanumeric symbols which are made of, for example, black glass enamel. Upon laser ablation, a “positive” marking is provided in which the alphanumeric symbols comprise the remaining glass enamel. Alternatively, the serial number may comprise a “negative” image in which the alphanumeric symbols are formed by removing the glass enamel in the symbol regions, leaving a background of the glass enamel in the other regions.

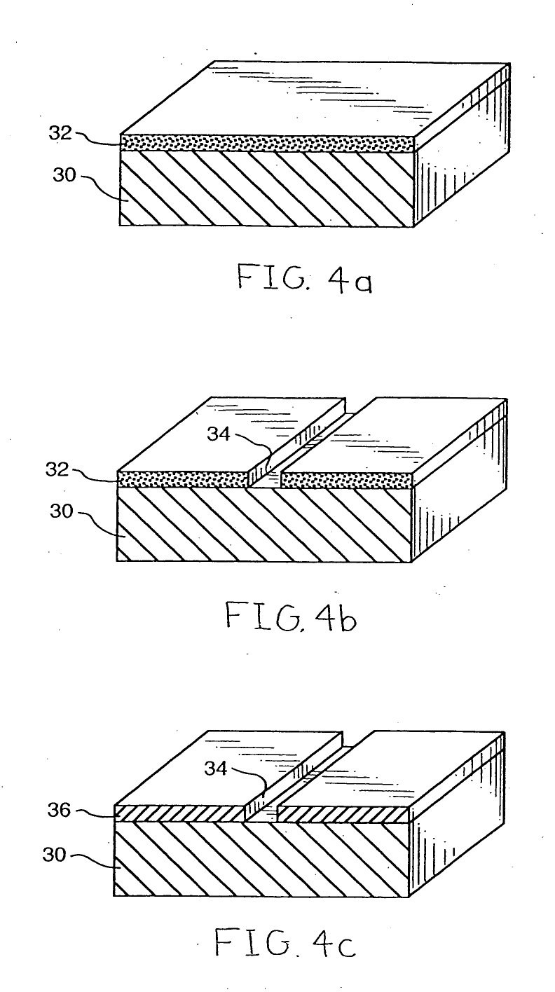

FIGS. 4a-4c illustrate a laser ablation method that may be used in accordance with an embodiment of the present invention. In FIG. 4a, a substrate 30 has a layer of screen printed material 32 applied thereto. FIG. 4b illustrates the substrate 30 and screen printed material 32 after a portion of the screen printed material has been removed by a laser beam (not shown) which preferably travels across the upper surface of the substrate 30 to form a groove 34 in the screen printed material 32. While the entire thickness of the portion of screen printed material is removed to form the groove 34 in FIG. 4b, partial removal is possible wherein a layer of the screen printed material remains at the bottom of the groove. The remaining screen printed material 32 shown in FIG. 4b is then fired in order to convert it to a permanent marking 36, as shown in FIG. 4c. The adhered layer 36 and groove 34 shown in FIG. 4c provide a permanent marking on the substrate 30.

In accordance with the present invention, various substrate materials can be marked. For example, the present method may be used to mark glass, ceramic, brick, stone, metal, composite and plastic substrates. Exemplary glass substrate compositions include lead as well as lead-free glasses such as soda lime silicates, borosilicates, aluminum silicates, fused silica and the like. Typical ceramic substrates include tiles, sanitary ware, stoneware bodies, porcelain bodies and bricks, as well as electronic quality ceramic substrates such as silica, alumina, aluminum nitride, etc. Stone substrates include marble, granite, slate, limestone and the like. Suitable metal substrates include steel, brass, copper, aluminum, tin, zinc and the like. Typical plastic substrates include PVC, polyamides, polyolefins, polyethylenes, polycarbonates and polytetrafluoroethylene. Combinations of the above substrate materials may also be used, such as porcelain enameled steel substrates, glass coated ceramic bodies and glass enameled bodies.

Substrates that may be marked in accordance with the present invention include automotive parts, automotive glass, aerospace parts, medical devices, electronic devices, tooling, consumer products, packaging, glass bottles, metal cans, metal tags, bricks, tiles, plumbing, electrical, construction supplies, lighting and the like.

The screen printed material may comprise a marking component which is used to form a permanent marking on the substrate and a removable medium which is used to facilitate removal of a portion of marking material from the substrate upon irradiation. The marking component may comprise from about 10 to 100 weight percent of the screen printed material, for example, from about 40 to about 99 weight percent. The removal medium may typically comprise from 0 to about 90 weight percent of the screen printed material, for example, from about 1 to about 60 weight percent.

In a preferred embodiment, the screen printed material has a composition comprising from about 35 to about 75 weight percent glass frit, from about 5 to about 40 weight percent pigment, from zero to about 25 weight percent crystal seed powder, and from about 10 to about 40 weight percent printing medium. More preferably, the screen printed material comprises from about 40 to about 60 weight percent glass frit, from about 10 to about 35 weight percent pigment, from zero to about 25 weight percent crystal seed powder, from zero to about 10 weight percent metal and/or metal oxide materials, and from about 15 to about 40 weight percent printing medium.

The glass frit of the screen printed material may comprise lead-containing frit and/or lead-free frit. As used herein, the term “glass frit” means pre-fused glass material which is typically produced by rapid solidification of molten material followed by grinding or milling to the desired powder size. Preferred glass frits may comprise from 0 to about 75 weight percent lead oxide, from 0 to about 75 weight percent bismuth oxide, from 0 to about 75 weight percent silica, from 0 to about 50 weight percent zinc oxide, from 0 to about 40 weight percent boron oxide, from 0 to about 15 weight percent aluminum oxide, from 0 to about 15 weight percent zirconium oxide, from 0 to about 8 weight percent titanium oxide, from 0 to about 20 weight percent phosphorous oxide, from 0 to about 15 weight percent calcium oxide, from 0 to about 10 weight percent manganese oxide, from 0 to about 7 weight percent copper oxide, from 0 to about 5 weight percent cobalt oxide, from 0 to about 15 weight percent iron oxide, from 0 to about 20 weight percent sodium oxide, from 0 to about 20 weight percent potassium oxide, from 0 to about 15 weight percent lithium oxide and from 0 to about 7 weight percent fluoride, as well as other oxides conventionally used in glass frit compositions.

In addition to glass frit, precursors of such glass frit materials may be used as the marking component. Examples of glass frit precursors include metal oxides with glass formers, such as silica, zinc oxide, bismuth oxide, sodium borate, sodium carbonate, feldspars, fluorides, and the like.

The pigment of the screen printed material may comprise inorganic pigments such as spinels, zircons, rutiles, garnets, hematites, ultramarines and the like may also be used as the marking component. In addition to inorganic pigments, precursors thereof are useful in forming high quality marks. For example, a light green colored mixture of titanium dioxide, antimony trioxide and chrome oxide, which is the precursor to Cr—Sb—Ti buff, may be used. Such a precursor mixture may be dispersed in a removable medium, screen printed on a substrate, and partially removed therefrom with a laser beam. The remaining portion of the screen printed material is then fired to give a buff colored mark.

The crystal seed powder of the screen printed material may comprise, for example, bismuth silicate, zinc silicate and/or zinc borate.

Metal oxides, sulfides, nitrides, carbides and salts are also suitable marking components. For example, cobalt oxide, copper oxide, iron oxide, praseodymium oxide, copper sulfide, iron sulfide, nickel sulfide, aluminum nitride, titanium nitride, chrome carbide and tungsten carbide may be used.

Furthermore, metal powders such as iron, copper, nickel, silver, chromium and the like, may be used.

The above-noted marking components may be used alone or in various combinations in accordance with the present invention. For example, a combination of metal oxides with glass frit, metal oxides with metal sulfides or inorganic pigments with glass frits may be used.

In accordance with an embodiment of the present invention, the screen printed material may include removable media such as water, alcohols, polyols, chlorinated solvents, amines, esters, glycol ethers, ketones, terpenes, petroleum naphthas, aromatic hydrocarbons and natural oils. Other suitable removable media include furans, isoparaffins, N,N dimethylformamide, dimethylsulfoxide and tributylphosphine.

In addition to the marking component and optional removable medium, the screen printed materials of the present invention may comprise small amounts of binder materials to improve green strength or package stability. Additions may include epoxies, polyesters, acrylics, cellulosics, vinyls, natural proteins, styrenes, polyalkyls, carbonates, rosins, rosin esters, alkyls, drying oils, and polysaccharides such as starches, guar, extrins and alginates, and the like. The screen printed materials may optionally include additives generally known in the art to improve dispersability, wetting, flow and rheology, and to relieve surface defects.

The substrate surface is screen printed with a dispersion of the marking material powders in a suitable media. Water based media are preferred because of their minimal environmental impact, but solvent based media can also be used to control drying rate, dispersion or moisture sensitivity of certain marking materials. The deposited layer may typically be dried prior to the irradiation step, however this is not necessary. The marking material may be applied as a single layer, or may be applied as two or more layers.

The screen printed material is typically applied to the surface of the substrate with a total thickness of at least 0.1 micron, preferably from about 1 micron to about 1 mm, more preferably from about 5 to 200 microns, and most preferably from about 10 to about 100 microns.

After the enamel or other marking material is screen printed onto the surface of the substrate, the laser ablation portion of the screen printed material is subjected to laser treatment in order to remove some of the material from the substrate, thereby forming indicia such as serialization. Removal of the material may be achieved, for example, by vaporization, evaporation, thermal decomposition or sublimation of the material upon irradiation by the beam. Removal may alternatively be achieved by physically altering a portion of the screen printed material with the beam, followed by subsequent vacuuming, brushing, blowing off or the like to complete the removal step. A laser is preferably used to selectively remove the desired area of screen printed material. However, other forms of focused energy may be used in accordance with the present invention. Removal may be achieved by moving a laser beam over a stationary substrate using conventional beam steering methods, or by moving the substrate in relation to the laser beam. Laser ablation is typically achieved by directing the beam directly against the layer of screen printed material, but may also be achieved by directing the beam through a sufficiently transparent substrate. The laser beam may be directed perpendicularly with respect to the substrate, or at any other suitable angle which facilitates removal of the screen printed material from the substrate.

Suitable lasers for use in the laser ablation step of the present invention include neodymium:yttrium aluminum garnet (Nd:YAG) lasers, carbon dioxide (CO₂) lasers, diode lasers, excimer lasers and the like.

Typical YAG lasers emit light in the near-infrared spectrum at a wavelength of 1064 nm. Such lasers typically have continuous power outputs of from about 1 to about 50 watts, and can be operated in a pulsed mode at peak powers of from about 1 watt to about 45 kilowatts. For pulsed mode operation, frequencies of from about 1 to about 64,000 pulses/second may be used.

Typical CO₂ lasers emit light in the far-infrared region of the spectrum, with intensity spikes at wavelengths of 9.8 and 10.6 microns. Such CO₂ lasers typically operate at a continuous output power of from about 1 to about 40 watts.

In contrast with laser marking methods that use a laser beam to fuse or adhere the irradiated portion of a material to a substrate, the present method uses a laser beam to remove or ablate a portion of the screen printed material from a portion of the substrate. In accordance with the preferred embodiment, pulsed mode laser operation is used to promote removal of the screen printed material. While continuous wave laser operation provides a steady stream of heat energy to the material, pulsing laser operation is believed to provide discontinuous bursts of energy which facilitate removal of the material from the substrate in the irradiated areas. Preferred pulse rates are from about 10 to about 64,000 pulses/second or higher, more preferably from about 500 to about 20,000 pulses/second.

In accordance with the present invention, the size of the laser spot that impinges the screen printed material is typically greater than 0.1 micron in diameter, preferably from about 40 to about 500 microns, and more preferably from about 50 to about 125 microns. The speed at which the laser beam travels across the surface of the marking material preferably ranges from 0 to about 100 inches/second (up to about 250 cm/second), more preferably from about 1 or 2 to about 20 inches/second (about 2.5 or 5 to 50 cm/second) for most thicknesses and compositions of marking material. The laser beam may be projected with a seam overlap of 0 to 100 percent, preferably from about 10 to about 90 percent for many applications. The laser parameters are controlled in order to provide sufficient localized removal of the screen printed material while avoiding unwanted damage to the substrate.

For many laser marking operations, a Lumonics LightWriter SPe YAG laser operating under the following parameters is suitable. Typically, laser ablation on a glass substrate may be achieved using pulse rates of from about 10 to about 64,000 pulses/second or higher, lamp currents from about 28 to about 38 amps, marking speeds from about 1 to about 20 inches/second (about 2.5 to 50 cm/second), laser dot sizes from about 0.002 to about 0.01 inches (about 50 and 250 microns), and seam overlaps from about 25 to about 50 percent. Laser ablation is typically performed with the beam in focus, but may also be carried out with the beam out of focus. Pulse rates of from about 1,000 to about 10,000 pulses/second, lamp currents of from about 28.5 to about 30 amps and writing speeds of from about 2 to about 5 inches/second (about 5 to 12.7 cm/second) are particularly advantageous for many ablation operations.

The laser beam, the movement of which can be controlled by a computer, may be used to ablate discrete symbols or designs or, alternatively, may be serially indexed across the surface of the screen printed material to create multiple symbols or designs at the same time. For example, a serial number may be created by separately ablating individual numbers with the laser, or by rastering the laser across the entire serial number to ablate all of the numbers at the same time. A single laser beam may be used for removal of the screen printed material in accordance with the present invention. Alternatively, two or more laser beams may be used.

In accordance with a preferred embodiment, substrate surface damage caused by the laser ablation process may be minimized or eliminated. While not intending to be bound by any particular theory, it is believed that the heat generated by the laser beam may be consumed by ablating the screen printed material from the surface rather than overheating the substrate and creating surface damage such as micro-cracks.

During the laser ablation step, the surface of the substrate may be exposed to any desired type of atmosphere. For example, the atmosphere may comprise air at atmospheric, sub-atmospheric or super-atmospheric pressures. Furthermore, the atmosphere may comprise an inert gas such as nitrogen, argon or carbon dioxide, an oxidizing atmosphere such as air or oxygen, a reducing atmosphere such as hydrogen or carbon monoxide, or a vacuum. Oxidizing or reducing gases can be used in a combination with inert gases. It is also possible to control the atmosphere on the surface of the substrate through the type of media the marking component is dispersed in. The atmosphere to which the surface of the substrate is exposed may affect the color and the quality of the mark.

In accordance with the present invention, after a portion of the screen printed material has been ablated from the substrate, the remaining portion of the screen printed material is permanently adhered to the substrate upon firing of the glass substrate in a furnace. As used herein, the term adhere is used to designate any permanent means of attachment of the remaining screen printed material to the substrate. For example, the remaining screen printed material may be adhered to the substrate by sintering the marking material to the substrate, fusing the marking material to the surface of the substrate, diffusing the marking material into the substrate, reacting the marking material with the substrate and the like. As used herein, the term permanent marking means a non-temporary marking which, for example, possesses relatively high wear resistance, corrosion resistance and/or fading resistance.

Various types of marks may be produced by the laser ablation step in accordance with the present invention. For example, the marks may comprise alphanumeric symbols, graphics, logos, designs, decorations, serializations, bar codes, two dimensional matrices and the like. By using conventional laser controlled hardware and software, the laser ablation markings may be quickly varied from operation to operation for applications such as serialization, bars codes, patch codes, manufacturing quality control and automated manufacturing.

In accordance with the present invention, screen printed and laser ablated permanent markings may be formed with high contrast and high resolution. In addition, the present markings have favorable wear, corrosion and fade resistance properties. For example, marks created with glass frits have wear, corrosion and fade resistance properties similar to the resistance of the glass from which the frit was made.

Whereas particular embodiments of this invention have been described above for purposes of illustration, it will be evident to those skilled in the art that numerous variations of the details of the present invention may be made without departing from the invention as defined in the appended claims.

What is claimed is:

1. A method of providing indicia on a piece of automotive glass, comprising:
a. screen printing the automotive glass with a single layer of material having a thickness to form a coating on the glass,
b. laser ablating a portion of the coating using a laser, to provide the indicia on the automotive glass, wherein at least a portion of the thickness of the coating is removed during the laser ablating, and wherein none of the automotive glass is removed or damaged during the laser ablating.

2. The method of claim 1, further comprising firing the automotive glass after the laser ablating.

3. The method of claim 2, further comprising bending the automotive glass after the laser ablating.

4. The method of claim 2, wherein the automotive glass is bent during the firing.

5. The method of claim 1, further comprising bending the automotive glass after the screen printing.

6. The method of claim 1, further comprising bending the automotive glass after the laser ablating.

7. The method of claim 1, wherein the automotive glass includes a periphery and the coating formed during said step 1a comprises a border formed along said periphery of the automotive glass and a laser ablation portion that is ablated during said step 1b.

8. The method of claim 1, wherein subsequent to said step 1b said laser ablation portion comprises a part number for the automotive glass.

9. The method of claim 1, wherein the coating further comprises a logo.

10. The method of claim 1 further comprising screen printing the automotive glass with a second layer of material to form a second coating on the glass.

11. The method of claim 1 wherein the laser is selected from the group consisting of neodymium yttrium aluminum garnet lasers, carbon dioxide lasers, diode lasers, and excimer lasers.

12. The method of claim 10 wherein the laser is a neodymium yttrium aluminum garnet laser.

13. The method of claim 10 wherein the laser is a carbon dioxide laser.

14. The method of claim 1, wherein the indicia comprise a feature selected from the group consisting of a serial number, bar code, patch code, logo, manufacturing information of the automotive glass and combinations thereof.

15. The method of claim 1, wherein the indicia comprise an automobile serial number.

16. The method of claim 1, wherein the coating applied during said step 1a comprises glass frit, pigment, crystal seed powder, and printing medium.

17. The method of claim 16 wherein the crystal seed powder is selected from the group consisting of bismuth silicate, zinc silicate and zinc borate, and combinations thereof.

18. The method of claim 17, wherein the coating applied during said step 1a comprises from about 35 to about 75 weight percent glass frit, from about 5 to about 40 weight percent pigment, from about 10 to about 40 weight percent printing medium, and further comprises up to about 25 weight percent crystal seed powder, and up to about 10 weight percent metal+metal oxide materials,

19. The method of claim 18, wherein the coating applied during said step 1a comprises: from about 40 to about 60 weight percent glass frit, from about 10 to about 35 weight percent pigment, from about 15 to about 40 weight percent printing medium, up to about 25 weight percent crystal seed powder, and up to about 10 weight percent metal+metal oxide materials.
